(19) United States
(12) Patent Application Publication
(10) Pub. No.: US 2026/0162954 A1
(43) Pub. Date: Jun. 11, 2026

(54) MANUFACTURING METHOD FOR ELECTRODE

(71) Applicant: Prime Planet Energy & Solutions, Inc., Tokyo (JP)

(72) Inventor: Kazuhiro MAEDA, Himeji-shi (JP)

(21) Appl. No.: 19/406,942

(22) Filed: Dec. 3, 2025

(30) Foreign Application Priority Data
Dec. 5, 2024 (JP) 2024-212526

(51) Int. Cl. H01M 4/04; H01M 4/02; H01M 4/139

(52) U.S. Cl. CPC H01M 4/0404; H01M 4/139; H01M 2004/028

(57) ABSTRACT

The present disclosure provides a manufacturing method for the electrode including the electrode mixture layer and the protection layer adjacent thereto on a current collector foil. The manufacturing method includes coating the current collector foil with an electrode mixture slurry and a protection layer formation slurry using a die head including a shim; and drying these slurries. The protection layer formation slurry is subjected to die coating simultaneously with the electrode mixture slurry so that the protection layer formation slurry is adjacent to the electrode mixture slurry. The shim includes a discharge port for discharging the electrode mixture slurry and a discharge port for discharging the protection layer formation slurry. A ratio (B/A) of an opening width B of the discharge port for discharging the protection layer formation slurry to a coating width A of the protection layer formation slurry is 1.00 to 1.07.

### CROSS REFERENCE TO RELATED APPLICATION

This application claims the benefit of priority to Japanese Patent Application No. 2024-212526 filed on Dec. 5, 2024. The entire contents of this application are incorporated herein by reference.

### BACKGROUND OF THE DISCLOSURE

The present disclosure relates to a manufacturing method for an electrode including an electrode mixture layer and a protection layer adjacent to the electrode mixture layer on a current collector foil.

In recent years, secondary batteries such as lithium ion secondary batteries have been suitably used for portable power sources of personal computers, mobile terminals, and the like; driving power sources of vehicles such as a battery electric vehicle (BEV), a hybrid electric vehicle (HEV), and a plug-in hybrid vehicle (PHEV); and the like.

As an electrode of a secondary battery such as a lithium ion secondary battery, an electrode including an electrode mixture layer and a protection layer adjacent to the electrode mixture layer on a current collector foil has been known (for example, see Japanese Patent Application Publication No. 2021-131988). As a method for forming the electrode mixture layer and the protection layer on the current collector foil, for example, a method of die-coating an electrode mixture slurry and a protection layer formation slurry on the current collector foil at the same time using a coating device disclosed in Japanese Patent Application Publication No. 2021-131988 and Japanese Patent Application Publication No. 2021-120148 has been known.

In the aforementioned coating device, a die head includes a shim where a flow channel of the electrode mixture slurry and a flow channel of the protection layer formation slurry are provided (for example, see Japanese Patent Application Publication No. 2021-120148). In addition, the shim includes a discharge port for the electrode mixture slurry and a discharge port for the protection layer formation slurry. Normally, the opening width of the discharge port for the protection layer formation slurry in the shim is set to be narrower than the coating width of the protection layer formation slurry in consideration of wetting and spreading of the slurry after the coating.

### SUMMARY

Here, the thickness of the protection layer of the electrode is desirably smaller as long as the insulating property can be kept. In the conventional methods, however, it is difficult to reduce the thickness of the protection layer while keeping the adjacent state between the protection layer and the electrode mixture layer favorable.

In view of the above circumstance, it is an object of the present disclosure to provide a manufacturing method for an electrode, in which the thickness of a protection layer can be reduced while the adjacent state between the protection layer and an electrode mixture layer is kept favorable.

The present disclosure provides a manufacturing method for an electrode including an electrode mixture layer and a protection layer adjacent to the electrode mixture layer on a current collector foil. The manufacturing method includes a step of coating the current collector foil with an electrode mixture slurry and a protection layer formation slurry using a die head including a shim, and a step of drying the coating electrode mixture slurry and protection layer formation slurry. The protection layer formation slurry is subjected to die coating simultaneously with the electrode mixture slurry so that the protection layer formation slurry is adjacent to the electrode mixture slurry. The shim includes a discharge port for discharging the electrode mixture slurry and a discharge port for discharging the protection layer formation slurry. A ratio (B/A) of an opening width B of the discharge port for discharging the protection layer formation slurry to a coating width A of the protection layer formation slurry is 1.00 to 1.07.

Such a structure can provide the manufacturing method for the electrode, in which the thickness of the protection layer can be reduced while the adjacent state between the protection layer and the electrode mixture layer is kept favorable.

### BRIEF DESCRIPTION OF THE DRAWINGS

FIG. 1 is a flowchart showing each step of a manufacturing method according to one embodiment of the present disclosure;

FIG. 2 is a schematic cross-sectional view of one example of a positive electrode obtained by the manufacturing method according to one embodiment of the present disclosure;

FIG. 3 is a schematic view in which one example of the positive electrode obtained by the manufacturing method according to one embodiment of the present disclosure is viewed from a direction perpendicular to a main surface;

FIG. 4 is a plan view of a shim of a die head used in a coating step in the manufacturing method according to one embodiment of the present disclosure;

FIG. 5 is a view schematically illustrating die coating in the coating step in the manufacturing method according to one embodiment of the present disclosure;

FIG. 6 is a view schematically illustrating an aspect of the die coating in the coating step in the manufacturing method according to one embodiment of the present disclosure;

FIG. 7A to FIG. 7C are schematic cross-sectional views of the positive electrode for describing the adjacent state between a positive electrode mixture layer and a protection layer; and

FIG. 8 is a view schematically illustrating an aspect of conventional die coating.

### DETAILED DESCRIPTION OF THE EMBODIMENTS

Embodiments of the present disclosure will hereinafter be described with reference to the drawings. Matters that are not mentioned in the present specification and that are necessary for carrying out the present disclosure can be grasped as design matters of those skilled in the art based on the prior art in the relevant field. The present disclosure can be carried out on the basis of the contents disclosed in the present specification and common technical knowledge in the relevant field. In the drawings below, the members and parts with the same operation are explained by being denoted by the same reference sign. In addition, the size relation (length, width, thickness, etc.) in each drawing does not necessarily reflect the actual size relation. Moreover, in the present specification, the numerical range expressed as “A to B” includes A and B.

It should be noted that, in the present specification, the term “secondary battery” herein refers to a power storage device capable of being repeatedly charged and discharged. A “lithium ion secondary battery” herein refers to a secondary battery that uses lithium ions as charge carriers and performs charge and discharge by movement of charges accompanying lithium ions between positive and negative electrodes.

A manufacturing method for an electrode according to the present disclosure is a manufacturing method for an electrode including an electrode mixture layer and a protection layer adjacent to the electrode mixture layer on a current collector foil. As illustrated in FIG. 1, the manufacturing method includes a step (hereinafter also referred to as “coating step”) S101 of coating the current collector foil with an electrode mixture slurry and a protection layer formation slurry using a die head including a shim, and a step (hereinafter also referred to as “drying step”) S102 of drying the coating electrode mixture slurry and protection layer formation slurry. The protection layer formation slurry is subjected to die coating simultaneously with the electrode mixture slurry so that the protection layer formation slurry is adjacent to the electrode mixture slurry. The shim includes a discharge port for discharging the electrode mixture slurry and a discharge port for discharging the protection layer formation slurry. A ratio (B/A) of an opening width B of the discharge port for discharging the protection layer formation slurry to a coating width A of the protection layer formation slurry is 1.00 to 1.07.

An electrode obtained by the manufacturing method according to the present disclosure is typically a positive electrode of a lithium ion secondary battery. Therefore, as an example of the manufacturing method according to the present disclosure, an embodiment in which a positive electrode of a lithium ion secondary battery is manufactured will hereinafter be described. It should be noted that the electrode manufactured by the manufacturing method according to the present disclosure is not limited to the positive electrode of the lithium ion secondary battery. The electrode manufactured by the manufacturing method according to the present disclosure may be a negative electrode of a lithium ion secondary battery or an electrode of a battery other than a lithium ion secondary battery as long as having an electrode mixture layer and a protection layer adjacent to the electrode mixture layer on a current collector foil.

### [Positive Electrode of Lithium Ion Secondary Battery]

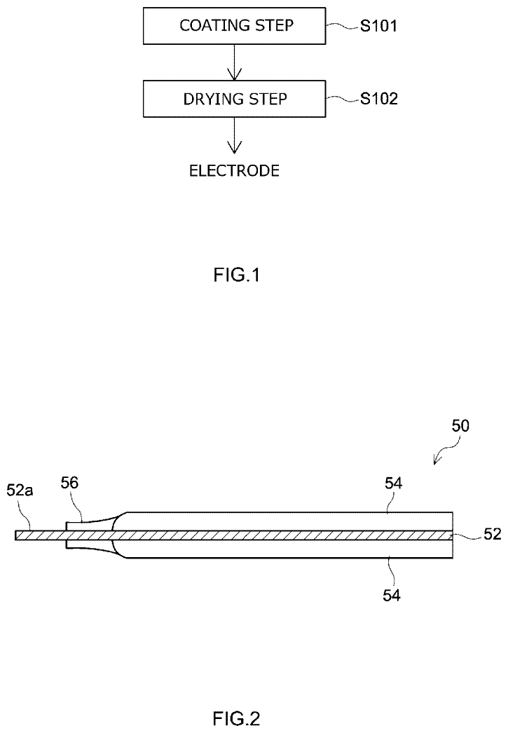

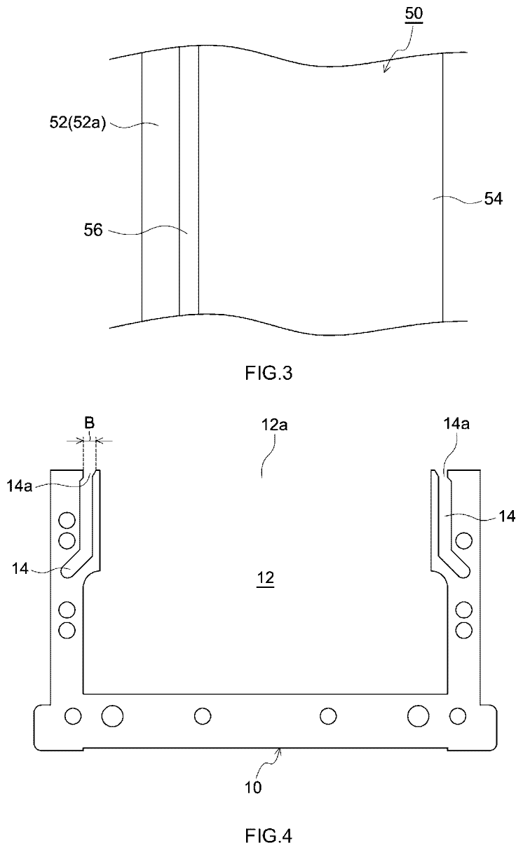

First, one example of a positive electrode of a lithium ion secondary battery obtained by a manufacturing method according to this embodiment is illustrated in FIG. 2 and FIG. 3. FIG. 2 is a cross-sectional view taken along a width direction and a thickness direction of the positive electrode. FIG. 3 is a schematic view in which the positive electrode is viewed from a direction perpendicular to a main surface thereof.

A positive electrode 50 in the illustrated example is configured as a positive electrode sheet with an elongated shape, and FIG. 3 illustrates just a part. However, the positive electrode may be cut into a predetermined size and may have a shape other than the elongated shape. As illustrated in FIG. 2 and FIG. 3, the positive electrode 50 includes a positive electrode current collector foil 52 and a positive electrode mixture layer 54 formed on the positive electrode current collector foil 52. In the illustrated example, the positive electrode mixture layer 54 is provided on both surfaces of the positive electrode current collector foil 52. However, the positive electrode mixture layer 54 may be provided on only one surface of the positive electrode current collector foil 52.

A main surface of the positive electrode current collector foil 52 includes a part (positive electrode current collector foil exposed part) 52a where the positive electrode mixture layer 54 is not formed and the positive electrode current collector foil 52 is exposed. In the illustrated example, the positive electrode current collector foil exposed part 52a is provided at one end part of the positive electrode 50 in the width direction thereof. The positive electrode current collector foil exposed part 52a, however, may be provided at an end part of the positive electrode 50 in a longitudinal direction thereof. Alternatively, the positive electrode current collector foil exposed part 52a may be provided at two or more end parts of the positive electrode 50.

The positive electrode 50 includes a protection layer 56. The protection layer 56 is a layer with an insulating property. The protection layer 56 prevents the direct contact between the positive electrode current collector foil exposed part 52a of the positive electrode 50 and the negative electrode, thereby suppressing the short-circuiting between the positive electrode 50 and the negative electrode. In the illustrated example, the protection layer 56 is provided on both surfaces of the positive electrode current collector foil 52. However, the protection layer 56 may be provided on only one surface of the positive electrode current collector foil 52.

The protection layer 56 is adjacent to the positive electrode mixture layer 54, and exists between the positive electrode mixture layer 54 and the positive electrode current collector foil exposed part 52a in a surface direction of the positive electrode sheet 50. In other words, the protection layer 56 exists at a border part between the positive electrode mixture layer 54 and the positive electrode current collector foil exposed part 52a. By the provision of the protection layer 56 at this position, the short-circuiting between the positive electrode 50 and a negative electrode 60 can be suppressed at a high degree.

The positive electrode current collector foil 52 is a foil-shaped body of metal such as aluminum or an aluminum alloy. The positive electrode current collector foil 52 is desirably an aluminum foil. The thickness of the positive electrode current collector foil 52 is not limited in particular and is, for example, 5 μm or more and 35 μm or less and desirably 7 μm or more and 20 μm or less.

The positive electrode mixture layer 54 contains a positive electrode active material. As the positive electrode active material, a known positive electrode active material used for the lithium ion secondary battery may be used. Specifically, for example, a lithium composite oxide, a lithium transition metal phosphate compound, or the like can be used as the positive electrode active material.

Examples of the lithium composite oxide include lithium nickel composite oxides, lithium cobalt composite oxides, lithium manganese composite oxides, lithium nickel manganese composite oxides, lithium nickel cobalt manganese composite oxides, lithium nickel cobalt aluminum composite oxides, lithium iron nickel manganese composite oxides, and the like. In particular, the lithium nickel cobalt manganese composite oxide is desirable. Examples of the lithium transition metal phosphate compound include lithium iron phosphate (LiFePO₄), lithium manganese phosphate (LiMnPO₄), lithium manganese iron phosphate, and the like.

The average particle diameter of the positive electrode active material is not limited in particular and is, for example, 0.05 μm or more and 25 μm or less and desirably 1 μm or more and 20 μm or less. It should be noted that in the present specification, “the average particle diameter” refers to a median diameter (D50). The average particle diameter (D50) can be obtained using a known laser diffraction/scattering type particle size distribution measurement device or the like.

The positive electrode mixture layer 54 may include a component other than the positive electrode active material, such as trilithium phosphate, a conductive material, or a binder. Desired examples of the conductive material include carbon materials, for example, carbon black such as acetylene black (AB), and carbon nanotube. As the binder, for example, polyvinylidene fluoride (PVDF) or the like can be used.

The content of the positive electrode active material in the positive electrode mixture layer 54 (that is, the content of the positive electrode active material with respect to the entire mass of the positive electrode mixture layer 54) is not limited in particular and is desirably 80 mass % or more, and more desirably 90 mass % or more and 97.5 mass % or less. The content of trilithium phosphate in the positive electrode mixture layer 54 is not limited in particular and is desirably 1 mass % or more and 12 mass % or less and more desirably 3 mass % or more and 10 mass % or less. The content of the conductive material in the positive electrode mixture layer 54 is not limited in particular and is desirably 1 mass % or more and 10 mass % or less and more desirably 1.5 mass % or more and 7 mass % or less. The content of the binder in the positive electrode mixture layer 54 is not limited in particular and is desirably 1 mass % or more and 10 mass % or less and more desirably 1 mass % or more and 2.7 mass % or less.

The thickness of the positive electrode mixture layer 54 is not limited in particular and is, for example, 10 μm or more and 300 μm or less and desirably 20 μm or more and 200 μm or less.

The protection layer 56 contains an insulating filler for the insulating property. Examples of the insulating filler include a ceramic particle, a polymer particle, an organic-inorganic composite particle, and the like, and in particular, the ceramic particle is desirable.

Examples of the ceramic particle included in the protection layer 56 include: oxide-based ceramic particles of alumina, silica, titania, zirconia, magnesia, ceria, zinc oxide, and the like; nitride-based ceramic particles of silicon nitride, titanium nitride, boron nitride, and the like; hydroxide particles of calcium hydroxide, magnesium hydroxide, aluminum hydroxide, and the like; and clay mineral particles of mica, talc, boehmite, zeolite, apatite, kaolin, and the like. Among those above, the alumina particle, the boehmite particle, the silica particle, and the magnesia particle are desirable, and the alumina particle and the boehmite particle are more desirable. Alumina and boehmite are excellent in heat resistance, mechanical strength, and durability.

The shape of the ceramic particle is not limited in particular and may be spherical or aspherical. The average particle diameter (D50) of the ceramic particles is not limited in particular and is, for example, 0.01 μm or more and 10 μm or less, desirably 0.1 μm or more and 5 μm or less, and more desirably 0.2 μm or more and 2.0 μm or less.

The content of the ceramic particle in the protection layer 56 is not limited in particular and is, for example, 70 mass % or more, desirably 75 mass % or more, and more desirably 85 mass % or more.

The protection layer 56 may contain a binder. As the binder contained in the protection layer 56, for example, an acrylic binder, a styrene-butadiene rubber (SBR), a polyolefin binder, and the like are given, and a fluorine polymer such as polyvinylidene fluoride (PVDF) or polytetrafluoroethylene (PTFE) can also be used.

The content of the binder in the protection layer 56 is, for example, 1 mass % or more and 25 mass % or less, desirably 3 mass % or more and 20 mass % or less, and more desirably 3 mass % or more and 10 mass % or less, although there is no particular limitation.

The protection layer 56 may contain a carbon-based conductive material in the range of being able to keep the insulating property (that is, in the range of being able to suppress the short-circuiting between the positive electrode and the negative electrode). In the case where the protection layer 56 contains the carbon-based conductive material, the current collecting property of the positive electrode 50 is high.

Examples of the carbon-based conductive material included in the protection layer 56 include carbon black such as acetylene black, furnace black, channel black, thermal black, or Ketjen black, carbon nanotube, and the like. In the case of performing a current collector tab forming step, which will be described below, carbon black has a high performance of absorbing the heat at laser cutting and therefore can suppress the separation between the protection layer 56 and the positive electrode current collector foil 52; thus, carbon black is desirable. Among those carbon black, acetylene black is more desirable.

The content of the carbon-based conductive material in the protection layer 56 is, for example, 0.1 mass % or more and 5.0 mass % or less, desirably 0.2 mass % or more and 3.0 mass % or less, and more desirably 0.3 mass % or more and 1.0 mass % or less, although there is no particular limitation.

The positive electrode 50 may further include a layer other than the positive electrode mixture layer 54 and the protection layer 56 within the range not interrupting the effect of the present disclosure.

### [Coating Step S101]

The coating step S101 will be described. First, a positive electrode mixture slurry, which is the electrode mixture slurry, and the protection layer formation slurry are described.

The positive electrode mixture slurry includes the above-described constituent components of the positive electrode mixture layer 54 (that is, the positive electrode active material, the optional binder, the optional conductive material, and the like), and a dispersion medium. As the dispersion medium, N-methyl pyrrolidone (NMP) or the like can be suitably used. The positive electrode mixture slurry can be prepared by stirring and mixing, or kneading the above-described constituent components of the positive electrode mixture layer 54 and the dispersion medium in accordance with a known method.

The protection layer formation slurry includes the above-described constituent components of the protection layer 56 (that is, the insulating filler, the optional binder, the optional carbon-based conductive material, and the like), and a dispersion medium. As the dispersion medium, N-methyl pyrrolidone (NMP) or the like can be suitably used. The protection layer formation slurry can be prepared by stirring and mixing, or kneading the above-described constituent components of the protection layer 56 and the dispersion medium in accordance with the known method.

The solid content concentration of the positive electrode mixture slurry is desirably 70 mass % to 85 mass % and more desirably 80 mass % to 85 mass %, although there is no particular limitation. The solid content concentration of the protection layer formation slurry is desirably 15 mass % to 25 mass %, although there is no particular limitation. When the solid content concentration of the positive electrode mixture slurry and the solid content concentration of the protection layer formation slurry are in the aforementioned ranges, the adjacent state between the protection layer 56 and the positive electrode mixture layer 54 becomes particularly favorable.

A viscosity η_{A} of the positive electrode mixture slurry is, for example, 2.5 Pa·s to 5.0 Pa·s and desirably 4.0 Pa·s to 4.5 Pa·s, although there is no particular limitation. In addition, a viscosity η_{B} of the protection layer formation slurry is, for example, 0.9 Pa·s to 1.5 Pa·s and desirably 1.0 Pa·s to 1.31 Pa·s, although there is no particular limitation. It should be noted that the viscosity η_{A} of the positive electrode mixture slurry and the viscosity η_{B} of the protection layer formation slurry can be determined as a value of the viscosity at a shear rate of 100 s⁻¹ at 25° C. using a commercial rotary type viscometer.

A ratio (η_{A}/η_{B}) of the viscosity 1A of the positive electrode mixture slurry to the viscosity η_{B} of the protection layer formation slurry is desirably 3.05 to 4.5, although there is no particular limitation. When this ratio (η_{A}/η_{B}) is in this range, the adjacent state between the protection layer 56 and the positive electrode mixture layer 54 becomes particularly favorable.

It should be noted that in this specification, the term “slurry” refers to a mixture in which the solid content is partially or entirely dispersed in a solvent, and encompasses so-called “paste”, “ink”, and the like.

Next, the die coating in the coating step S101 is described. In the coating step S101, a coating device including a die head with a shim is prepared. This die head, for example, includes a pair of die blocks and a shim fixed between the pair of die blocks, which is similar to that of the conventional art described above.

The shim is a member that restricts the flow channels of the electrode mixture slurry and the protection layer formation slurry, and includes a discharge port for discharging the electrode mixture slurry and a discharge port for discharging the protection layer formation slurry. One example of the shim is illustrated in FIG. 4. FIG. 4 is a plan view illustrating one example of the shim.

A shim 10 illustrated in FIG. 4 includes a flow channel 12 of the positive electrode mixture slurry at a center. In addition, the shim 10 includes a pair of flow channels 14 of the protection layer formation slurry on both sides of the flow channel 12 of the positive electrode mixture slurry. In the case of using such a shim 10, the protection layer 56 can be formed at both ends of the positive electrode mixture layer 54 and by cutting a sheet having the protection layer 56 formed at both ends of the positive electrode mixture layer 54, at a central part thereof in its width direction, two positive electrodes 50 in a mode illustrated in FIG. 2 and FIG. 3 can be manufactured, which is advantageous in the productivity of the positive electrode 50. It should be noted that the shim 10 may employ the mode of having one flow channel 14 of the protection layer formation slurry next to the flow channel 12 of the positive electrode mixture slurry. In this case, the positive electrode 50 in the mode illustrated in FIG. 2 and FIG. 3 in which the protection layer 56 is formed at one end part of the positive electrode mixture layer 54 can be obtained directly.

A terminal end of the flow channel 12 of the positive electrode mixture slurry is open, and thus the shim 10 has a discharge port 12a for discharging the positive electrode mixture slurry. A terminal end of the flow channel 14 of the protection layer formation slurry is open, and thus the shim 10 has a discharge port 14a for discharging the protection layer formation slurry.

The flow channel 12 of the positive electrode mixture slurry and the flow channel 14 of the protection layer formation slurry are separated from each other so that the positive electrode mixture slurry and the protection layer formation slurry will not be mixed before the coating. The flow channel 14 of the protection layer formation slurry is configured to get close to the flow channel 12 of the positive electrode mixture slurry near the discharge port 14a for the protection layer formation slurry so that the positive electrode mixture slurry and the protection layer formation slurry are in contact with each other at the die coating. Thereby, the protection layer formation slurry is discharged from the discharge port 14a toward the positive electrode mixture slurry, so that the positive electrode mixture slurry and the protection layer formation slurry can be in contact with each other at the die coating.

FIG. 5 is a schematic view of an example of the die coating in the coating step S101. The coating device in the illustrated example includes a die head 20 and a back-up roll 30. In the die head 20, the shim 10 is held by a pair of die blocks 22 as illustrated in FIG. 5. In addition, the coating device includes a slurry supply unit (not illustrated). The slurry supply unit may be a known slurry supply unit. The positive electrode mixture slurry and the protection layer formation slurry are supplied from the slurry supply unit to the die head 20. On the other hand, the positive electrode current collector foil 52 with an elongated shape is conveyed as the back-up roll 30 rotates. The conveying speed of the positive electrode current collector foil 52 is, for example, 20 m/min to 80 m/min and desirably 30 m/min to 60 m/min, although there is no particular limitation.

The positive electrode mixture slurry and the protection layer formation slurry are discharged from the die head 20 toward this positive electrode current collector foil 52 through the discharge port 12a for the positive electrode mixture slurry and the discharge port 14a for the protection layer formation slurry, respectively. Thereby, the positive electrode mixture slurry and the protection layer formation slurry are subjected to coating on the positive electrode current collector foil 52 at the same time so that these slurries get adjacent to each other. In this manner, a coating film 42 of the positive electrode mixture slurry and a coating film 44 of the protection layer formation slurry are formed on the positive electrode current collector foil 52. The amount of discharge of the positive electrode mixture slurry and the amount of discharge of the protection layer formation slurry are not limited in particular, and may be determined as appropriate in accordance with the design values of the thickness and width of the positive electrode mixture layer 54 and the thickness and width of the protection layer 56. The amount of discharge of the protection layer formation slurry is, for example, 10 mL/min to 25 mL/min and desirably 15 mL/min to 20 mL/min.

Here, the opening width of the discharge port 14a of the shim for discharging the protection layer formation slurry is defined as B (see FIG. 4). Additionally, the coating width of the protection layer formation slurry is defined as A. It should be noted that the coating width A of the protection layer formation slurry is the dimension, in the width direction (that is, a direction perpendicular to the longitudinal direction), of the coating film 44 of the protection layer formation slurry illustrated in FIG. 5. This width direction is a direction perpendicular to the conveying direction of the positive electrode current collector foil 52. In the present disclosure, the ratio (B/A) of the opening width B of the discharge port for the protection layer formation slurry to the coating width A of the protection layer formation slurry is 1.00 to 1.07.

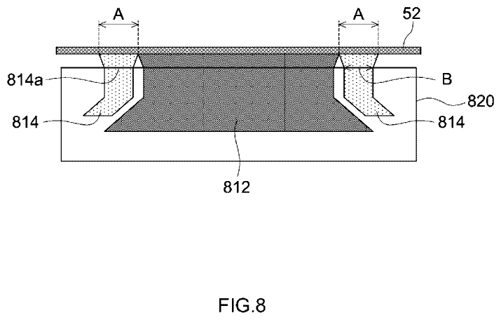

An aspect of the conventional die coating method is schematically illustrated in FIG. 8. In FIG. 8, flow channels 814 of the protection layer formation slurry are formed on both sides of a flow channel 812 of the positive electrode mixture slurry in a shim of a die head 820. The die head 820 and the positive electrode current collector foil 52 are apart from each other by a predetermined gap. The flow channel 814 of the protection layer formation slurry includes a discharge port 814a for the protection layer formation slurry. The positive electrode mixture slurry and the protection layer formation slurry pass these flow channels, are discharged from the discharge ports, and are subjected to coating on the positive electrode current collector foil 52. At this time, as illustrated in FIG. 8, the coating protection layer formation slurry wets the positive electrode current collector foil 52 and spreads thereon typically. Therefore, in consideration of this, the opening width B of the discharge port 814a for the protection layer formation slurry has conventionally been set to be narrower than the coating width A of the protection layer formation slurry. Specifically, the ratio (B/A) has conventionally been set to less than 1, particularly 0.95 or less.

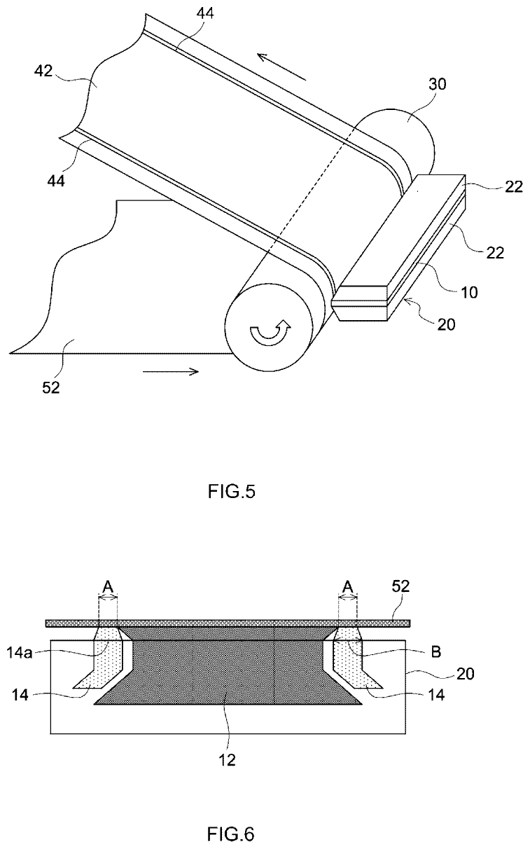

Therefore, in the present disclosure, the discharge port of the shim is designed so that the value of the ratio (B/A) becomes larger than the conventional one. FIG. 6 schematically illustrates an aspect of the die coating method in this embodiment. In this case, the opening width B is increased so that the dimension of the opening part of the discharge port 14a of the shim 10 for discharging the protection layer formation slurry becomes more than or equal to the coating width A of the protection layer formation slurry. In addition, since the amount of discharge is reduced for thinning the film, the protection layer formation slurry spreads more than that in the conventional method in the discharge port before being discharged and the flow rate is lower than that in the conventional method. The discharged protection layer formation slurry is drawn by the difference in speed from the current collector foil to be conveyed, whereby the protection layer formation slurry is subjected to coating in a narrower state than the opening width B without spreading on the current collector foil (see FIG. 6). As a result, it is possible to form the protection layer 56 with the smaller thickness than that in the conventional method because the protection layer formation slurry forms coating thinner than that in the conventional method while keeping the same coating width A as that in the conventional method. In addition, the adjacent state between the formed positive electrode mixture layer 54 and the formed protection layer 56 becomes favorable.

It should be noted that it is desirable to perform at least one of the following: the amount of discharge of the protection layer formation slurry is made smaller and the conveying speed of the positive electrode current collector foil 52 is made higher, than those in a condition to apply the protection layer formation slurry discharged from the discharge port 14a on the positive electrode current collector foil 52 while its thickness and width are kept. Thereby, the protection layer formation slurry discharged from the discharge port 14a is applied on the positive electrode current collector foil 52 in a state where at least one of the width and the thickness is smaller than that in the discharged state. For example, in a case where the amount of discharge of the protection layer formation slurry is 10 mL/min to 25 mL/min, the conveying speed of the positive electrode current collector foil 52 is desirably 20 m/min to 80 m/min.

The ratio (B/A) is desirably 1.03 to 1.07. At this time, the adjacent state between the protection layer and the electrode mixture layer can be made particularly favorable while the thickness of the protection layer to be obtained finally is reduced.

The coating width A of the protection layer 56 is not limited in particular and is, for example, 3 mm to 10 mm, and desirably 4 mm to 8 mm.

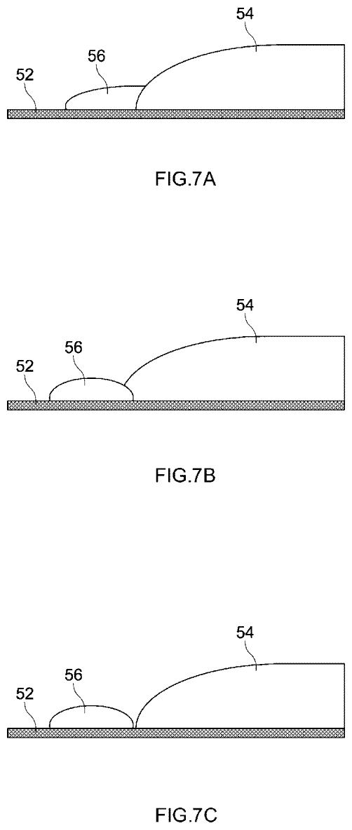

The adjacent state between the protection layer and the electrode mixture layer to be formed is described with reference to FIG. 7A to FIG. 7C. FIG. 7A to FIG. 7C are schematic cross-sectional views taken along the width direction and the thickness direction of the positive electrode. Since the slurry is fluid, an end part of a coating film of the slurry has a curved surface. In the example illustrated in FIG. 7A, the shape of the end part of the positive electrode mixture layer is close to a natural shape in the case where the positive electrode mixture slurry is subjected to coating. Therefore, the contour of the end part of the positive electrode mixture layer 54 is a curved line close to an elliptical arc, and the protection layer 56 is in contact with the end part of the positive electrode mixture layer 54. In the case of the example illustrated in FIG. 7A, the functions of the positive electrode mixture layer 54 and the protection layer 56 are sufficiently exhibited; therefore, the adjacent state between the positive electrode mixture layer 54 and the protection layer 56 is particularly favorable. In the example illustrated in FIG. 7B, the protection layer 56 enters a lower part of the positive electrode mixture layer 54. In the example illustrated in FIG. 7B, the protection layer 56 functions sufficiently; therefore, the adjacent state between the positive electrode mixture layer 54 and the protection layer 56 is favorable. On the other hand, in the illustrated in FIG. 7C, the protection layer 56 is apart from the positive electrode mixture layer 54. In the case of the example illustrated in FIG. 7C, there is a risk of short-circuiting in a gap between the positive electrode mixture layer 54 and the protection layer 56; therefore, the adjacent state between the positive electrode mixture layer 54 and the protection layer 56 is not favorable.

### [Drying Step S102]

Next, the drying step S102 is described. The drying step S102 can be performed in accordance with the known method.

For example, the drying step S102 can be performed by removing the dispersion medium of the positive electrode mixture slurry and the protection layer formation slurry from the positive electrode current collector foil 52 coated with the positive electrode mixture slurry and the protection layer formation slurry using a known drying device such as a drying furnace.

The drying temperature and the drying time are not limited in particular and may be determined as appropriate in accordance with the boiling point and the amount of the dispersion medium included in the positive electrode mixture slurry and the protection layer formation slurry. The drying temperature is, for example, 70° C. to 200° C. and desirably 110° C. to 180° C. The drying time is, for example, 20 seconds to 120 minutes and desirably 30 seconds to 20 minutes.

By performing the drying step S102, the positive electrode mixture layer 54 and the protection layer 56 can be formed on the positive electrode current collector foil 52. Thereby, the positive electrode 50 including the positive electrode mixture layer 54 and the protection layer 56 adjacent to the positive electrode mixture layer 54 on the positive electrode current collector foil 52 can be obtained.

In the obtained positive electrode 50, the adjacent state between the positive electrode mixture layer 54 and the protection layer 56 is favorable. Furthermore, the thickness of the protection layer 56 is small. Specifically, the thickness of the protection layer 56 can be set to 20 μm or less, 15 μm or less, or 12 μm or less. In addition, the thickness of the protection layer 56 can be 3 μm or more, 5 μm or more, or 7 μm or more. It should be noted that the thickness of the protection layer 56 is not limited in particular as long as being less than or equal to the thickness of the positive electrode mixture layer 54.

### [Optional Step]

An optional step in the manufacturing method according to the present disclosure will hereinafter be described. The manufacturing method according to this embodiment may further include a step of performing a pressing treatment (hereinafter also called “pressing treatment step”) on the formed positive electrode mixture layer 54 after the drying step S102.

The pressing treatment step can be performed in accordance with the known method (for example, by performing a roll-pressing treatment on the positive electrode mixture layer 54). This pressing treatment can increase the density of the positive electrode mixture layer 54, and thus can increase the energy density and the capacity of the lithium ion secondary battery.

As illustrated in FIG. 5, in the case of forming the protection layer 56 at both ends of the positive electrode mixture layer 54, the manufacturing method according to this embodiment may further include, after the drying step S102, a step of cutting a central part of the positive electrode current collector foil 52 in the width direction thereof together with the positive electrode mixture layer 54 so as to divide the obtained sheet into two positive electrodes (hereinafter this step is also called “dividing step”). This dividing step can be performed in accordance with the known method. Thereby, two positive electrodes 50 can be manufactured efficiently.

The manufacturing method according to this embodiment may further include a step of forming a current collector tab by laser-cutting a part of the positive electrode current collector foil exposed part 52a (this step is also called “current collector tab forming step” below) after the drying step S102. At the laser cutting, a part of the protection layer 56 may also be cut together with the positive electrode current collector foil 52. The current collector tab forming step can be performed in accordance with the known method.

It should be noted that in the case of performing two or more steps among the pressing treatment step, the dividing step, and the current collector tab forming step, the order of these steps is not limited in particular. Any step may be performed first.

The positive electrode 50 obtained in this manner can be used for the lithium ion secondary battery in accordance with the known method. Therefore, the manufacturing method for the electrode according to this embodiment is desirably a manufacturing method for the positive electrode of the lithium ion secondary battery.

The manufacture of the positive electrode of the lithium ion secondary battery has been described above as one example; however, the electrode to be obtained by the manufacturing method according to the present disclosure may be an electrode other than the positive electrode of the lithium ion secondary battery. The electrode obtained by the manufacturing method according to the present disclosure is desirably the electrode of the secondary battery.

The battery manufactured using the electrode obtained by the manufacturing method according to this embodiment, particularly the lithium ion secondary battery, is usable in various applications. The suitable applications of the lithium ion secondary battery are driving power sources to be mounted on vehicles such as an electric vehicle (EV), a hybrid vehicle (HV), and a plug-in hybrid vehicle (PHV), electrical energy storage batteries such as a small-sized electrical energy storage device, and the like.

Test Examples related to the present disclosure will hereinafter be described; however, it is not intended to limit the present disclosure to Test Examples below.

### Test Example 1

Lithium nickel cobalt manganese composite oxide, polyvinylidene fluoride (PVDF) as the binder, and acetylene black (AB) as the conductive material were mixed in N-methyl pyrrolidone, whereby a positive electrode mixture slurry (1) was manufactured. This positive electrode mixture slurry (1) had a solid content concentration of 77.5 mass % and a viscosity of 40 Pa·s.

In addition, alumina as the ceramic particle, polyvinylidene fluoride (PVDF) as the binder, and acetylene black (AB) as the carbon-based conductive material were mixed in N-methyl pyrrolidone, whereby a protection layer formation slurry (1) was manufactured. This protection layer formation slurry (1) had a solid content concentration of 24.5 mass % and a viscosity of 1.31 Pa·s.

The viscosity of each of the positive electrode mixture slurry (1) and the protection layer formation slurry (1) was obtained as follows. At room temperature (25° C.), the viscosity was measured at a shear speed of 0.01 s⁻¹ to 10,000 s⁻¹ using an MCR rheometer manufactured by Anton-Paar. The viscosity at a shear speed of 100 s⁻¹ was used as the viscosity of each of the positive electrode mixture slurry (1) and the protection layer formation slurry (1).

The shim having the discharge port and the flow channel for the positive electrode mixture slurry and the discharge port and the flow channel for the protection layer formation slurry as illustrated in FIG. 4 was prepared. Here, five kinds of shims whose opening widths (B) of the discharge ports for the protection layer formation slurry were 5.7 mm, 6.0 mm, 6.2 mm, 6.4 mm, and 6.6 mm were prepared. A die head coating device including each shim was prepared.

The positive electrode mixture slurry (1) and the protection layer formation slurry (1) were subjected to die coating simultaneously on a 13 μm-thick aluminum foil as the current collector foil so that the positive electrode mixture slurry (1) and the protection layer formation slurry (1) were adjacent to each other. At this time, the conveying speed of the aluminum foil was 45 m/min and the coating width (A) of the protection layer formation slurry (1) was 6 mm. The amount of discharge of the protection layer formation slurry (1) was the value shown in Table 1. After that, drying was performed to form the positive electrode mixture layer and the protection layer. Thereby, the positive electrode was obtained.

The thicknesses of the mixture layer and the protection layer of the obtained positive electrode were measured using a thickness gauge. Moreover, a border part between the positive electrode mixture layer and the protection layer in the cross section of the positive electrode was observed using a microscope. Here, the one in which the protection layer is adjacent to the positive electrode mixture layer without the protection layer entering the end part of the positive electrode mixture layer as illustrated in FIG. 7A is determined to be “excellent”, the one in which the end part of the protection layer enters the lower part of the end part of the positive electrode mixture layer as illustrated in FIG. 7B is determined to be “good”, and the one in which the positive electrode mixture layer and the protection layer are apart from each other as illustrated in FIG. 7C is determined to be “poor”. The “excellent” and “good” ones are determined to be acceptable. The results are shown in Table 1.

TABLE 1
Viscosity of positive electrode mixture slurry: 4.0 Pa · s, viscosity
of protection layer formation slurry: 1.31 Pa · s

| | Protection | Protection | | The | | Thickness | |
|---|---|---|---|---|---|---|---|
| | layer | layer | | amount of | Thickness | of | |
| | coating | opening | | discharge | of mixture | protection | Evaluation |
| | width (A) | width (B) | | of slurry | layer | layer | of adjacent |
| | (mm) | (mm) | B/A | (ml/min) | (μm) | (μm) | state |
| Comparative | 6 | 5.7 | 0.95 | 33 | 96.5 | 30 | Excellent |
| Example 1-1 | | | | | | | |
| Example 1-1 | 6 | 6.0 | 1.00 | 20 | 96.8 | 18 | Good |
| Example 1-2 | 6 | 6.2 | 1.03 | 19 | 99 | 17.6 | Excellent |
| Example 1-3 | 6 | 6.4 | 1.07 | 19 | 98.4 | 17.4 | Excellent |
| Comparative | 6 | 6.6 | 1.10 | 17 | 97.7 | 15.4 | Poor |
| Example 1-2 | | | | | | | |

### Test Example 2

A positive electrode mixture slurry (2) was manufactured in a manner similar to Test Example 1 except that the solid content concentration was changed to 80 mass % and the viscosity was changed to 4.5 Pa·s. In addition, a protection layer formation slurry (2) was manufactured in a manner similar to Test Example 1 except that the solid content concentration was changed to 15 mass % and the viscosity was changed to 1.0 Pa·s.

The positive electrode mixture slurry (2) and the protection layer formation slurry (2) were subjected to die coating simultaneously on the 13 μm-thick aluminum foil as the current collector foil using the same coating device as that of Test Example 1 in a manner similar to Test Example 1 so that the positive electrode mixture slurry (2) and the protection layer formation slurry (2) were adjacent to each other. The coating width (A) of the protection layer formation slurry (2) at this time was 6 mm. After that, drying was performed to form the positive electrode mixture layer and the protection layer Thereby, the positive electrode was obtained.

In a manner similar to Test Example 1, the thicknesses of the mixture layer and the protection layer of the obtained positive electrode were measured and the adjacent state between the positive electrode mixture layer and the protection layer was evaluated. The results are shown in Table 2.

TABLE 2
Viscosity of positive electrode mixture slurry: 4.5 Pa · s, viscosity
of protection layer formation slurry: 1.0 Pa · s

| | Protection | Protection | | The | | Thickness | |
|---|---|---|---|---|---|---|---|
| | layer | layer | | amount of | Thickness | of | |
| | coating | opening | | discharge | of mixture | protection | Evaluation |
| | width (A) | width (B) | | of slurry | layer | layer | of adjacent |
| | (mm) | (mm) | B/A | (ml/min) | (μm) | (μm) | state |
| Comparative | 6 | 5.7 | 0.95 | 33 | 97 | 18.4 | Excellent |
| Example 2-1 | | | | | | | |
| Example 2-1 | 6 | 6.0 | 1.00 | 20 | 96.2 | 11.4 | Good |
| Example 2-2 | 6 | 6.2 | 1.03 | 19 | 98 | 11 | Excellent |
| Example 2-3 | 6 | 6.4 | 1.07 | 19 | 98.4 | 10.5 | Excellent |
| Comparative | 6 | 6.6 | 1.10 | 17 | 97.2 | 10.2 | Poor |
| Example 2-2 | | | | | | | |

As indicated by the results in Table 1 and Table 2, when the ratio (B/A) of the opening width B of the discharge port for discharging the protection layer formation slurry to the coating width A of the protection layer formation slurry is 1.00 to 1.07, the adjacent state between the positive electrode mixture layer and the protection layer was favorable and the thickness of the positive electrode mixture layer was small.

Thus, it is understood that by the manufacturing method for the electrode according to the present disclosure, the adjacent state between the protection layer and the electrode mixture layer can be made favorable and at the same time, the thickness of the protection layer can be made small.

The specific examples of the present disclosure have been described above in detail; however, these are just examples and will not limit the scope of claims. The techniques described in the scope of claims include those in which the specific examples exemplified above are variously modified and changed.

That is to say, the manufacturing method for the electrode according to the present disclosure is the following Items [1] to [6].
[1] The manufacturing method for the electrode including the electrode mixture layer and the protection layer adjacent to the electrode mixture layer on the current collector foil, the manufacturing method including: the step of coating the current collector foil with the electrode mixture slurry and the protection layer formation slurry using the die head including the shim; and the step of drying the coating electrode mixture slurry and protection layer formation slurry, in which the protection layer formation slurry is subjected to the die coating simultaneously with the electrode mixture slurry so that the protection layer formation slurry is adjacent to the electrode mixture slurry, the shim includes the discharge port for discharging the electrode mixture slurry and the discharge port for discharging the protection layer formation slurry, and the ratio (B/A) of the opening width B of the discharge port for discharging the protection layer formation slurry to the coating width A of the protection layer formation slurry is 1.00 to 1.07.
[2] The manufacturing method according to Item [1], in which the ratio (B/A) of the opening width B of the discharge port for discharging the protection layer formation slurry to the coating width A of the protection layer formation slurry is 1.03 to 1.07.
[3] The manufacturing method according to Item [1] or [2], in which the positive electrode mixture slurry has a solid content concentration of 70 mass % to 85 mass %, and the protection layer formation slurry has a solid content concentration of 15 mass % to 25 mass %.
[4] The manufacturing method according to any one of Items [1] to [3], in which the viscosity η_{A} of the positive electrode mixture slurry at 25° C. at a shear speed of 100 s⁻¹ is 4.0 Pa·s to 4.5 Pa·s and the viscosity η_{B} of the protection layer formation slurry at 25° C. at a shear speed of 100 s⁻¹ is 1.0 Pa·s to 1.31 Pa·s.
[5] The manufacturing method according to any one of Items [1] to [4], in which the ratio (η_{A}/η_{B}) of the viscosity η_{A} of the positive electrode mixture slurry at 25° C. at a shear speed of 100 s⁻¹ to the viscosity η_{B} of the protection layer formation slurry at 25° C. at a shear speed of 100 s⁻¹ is 3.05 to 4.5.
[6] The manufacturing method according to any one of Items [1] to [5], in which the amount of discharge of the protection layer formation slurry is 10 mL/min to 25 mL/min and the conveying speed of the current collector foil is 20 m/min to 80 m/min.
[7] The manufacturing method according to any one of Items [1] to [6], in which the electrode is the positive electrode of the lithium ion secondary battery.

What is claimed is:

1. A manufacturing method for an electrode including an electrode mixture layer and a protection layer adjacent to the electrode mixture layer on a current collector foil, the manufacturing method comprising:
a step of coating the current collector foil with an electrode mixture slurry and a protection layer formation slurry using a die head including a shim; and
a step of drying the coating electrode mixture slurry and protection layer formation slurry, wherein
the protection layer formation slurry is subjected to die coating simultaneously with the electrode mixture slurry so that the protection layer formation slurry is adjacent to the electrode mixture slurry,
the shim includes a discharge port for discharging the electrode mixture slurry and a discharge port for discharging the protection layer formation slurry, and
a ratio (B/A) of an opening width B of the discharge port for discharging the protection layer formation slurry to a coating width A of the protection layer formation slurry is 1.00 to 1.07.

2. The manufacturing method according to claim 1, wherein the ratio (B/A) of the opening width B of the discharge port for discharging the protection layer formation slurry to the coating width A of the protection layer formation slurry is 1.03 to 1.07.

3. The manufacturing method according to claim 1, wherein the positive electrode mixture slurry has a solid content concentration of 70 mass % to 85 mass %, and the protection layer formation slurry has a solid content concentration of 15 mass % to 25 mass %.

4. The manufacturing method according to claim 1, wherein a viscosity η_{A} of the positive electrode mixture slurry at 25° C. at a shear speed of 100 s⁻¹ is 4.0 Pa·s to 4.5 Pa·s and a viscosity η_{B} of the protection layer formation slurry at 25° C. at a shear speed of 100 s⁻¹ is 1.0 Pa·s to 1.31 Pa·s.

5. The manufacturing method according to claim 1, wherein a ratio (η_{A}/η_{B}) of a viscosity η_{A} of the positive electrode mixture slurry at 25° C. at a shear speed of 100 s⁻¹ to a viscosity η_{B} of the protection layer formation slurry at 25° C. at a shear speed of 100 s⁻¹ is 3.05 to 4.5.

6. The manufacturing method according to claim 1, wherein an amount of discharge of the protection layer formation slurry is 10 mL/min to 25 mL/min and a conveying speed of the current collector foil is 20 m/min to 80 m/min.

7. The manufacturing method according to claim 1, wherein the electrode is a positive electrode of a lithium ion secondary battery.
